(19) United States
(12) Patent Application Publication
(10) Pub. No.: US 2007/0145816 A1
(43) Pub. Date: Jun. 28, 2007

(54) High clearance axle system

(76) Inventor: Gabe Gile, Arlington, WA (US)

Correspondence Address: SEED INTELLECTUAL PROPERTY LAW GROUP PLLC, 701 FIFTH AVE, SUITE 5400, SEATTLE, WA, 98104, US

(21) Appl. No.: 11/525,524

(22) Filed: Sep. 22, 2006

Related U.S. Application Data
(60) Provisional application No. 60/720,268, filed on Sep. 23, 2005.

(51) Int. Cl. B60B 35/00

(52) U.S. Cl. 301/132

(57) ABSTRACT

Apparatuses, systems, and methods for increasing ground clearance of vehicles are shown and described. High clearance axles can provide increased ground clearance so that the vehicle can travel over large obstacles. When a vehicle is driven over rough terrain, the axles can maintain proper alignment of the wheels mounted to the axle. The disclosed embodiments can be installed by either original equipment manufactures or aftermarket.

### CROSS-REFERENCE TO RELATED APPLICATION

This application claims the benefit under 35 U.S.C. § 119(e) of U.S. Provisional Patent Application No. 60/720,268 filed Sep. 23, 2005, which is incorporated herein by reference in its entirety.

### FIELD OF DISCLOSURE

The present disclosure generally relates to axle systems for transportation vehicles and, more particularly, to high clearance axle systems.

### DESCRIPTION OF THE RELATED ART

Transportation vehicles often have a front axle and rear axle to which a pair of front wheels and pair of rear wheels, respectively, are mounted. These axles can be drive axles or dead axles. Drive axles are connected to the vehicle's power train. Dead axles, on the other hand, are not part of a vehicle's drive train and permit free rotation of its wheels. For example, a front-wheel drive automobile can have a front drive axle and rear dead axle, whereas a rear-wheel drive automobile can have a rear drive axle and front dead axle. Four-wheel drive vehicles have front and rear drive axles.

Vehicles often have a relatively straight and hinged axle employing at least one rotatable shaft extending between a pair of opposing wheels. These types of axles often provide a relatively low amount of ground clearance. To increase ground clearance, vehicles (e.g., off-road vehicles) can be fitted with large diameter tires. Unfortunately, the straight axle may still contact large obstacles and become damaged when the vehicle travels over rough terrain. If the straight axle is a drive axle, a differential or other drive train component of the axle may become damaged, thus degrading the axle's performance. Large impacts can lead to axle misalignment or damage to the suspensions system or the axle itself. Additionally, passengers in the vehicle may feel these impacts, thus producing an uncomfortable ride. These low clearance straight axles are therefore unsuitable for traveling over, for example, rough terrain with relatively high obstacles, such as rocks, boulders, logs, and the like.

### BRIEF SUMMARY OF THE INVENTION

Some embodiments disclosed herein include the realization that a rigid axle assembly can have an elevated central section for providing increased ground clearance. The central section can be displaced upwardly from the free ends of the axle. When the axle assembly is installed, a suspension system can permit relatively large range of motion of the axle assembly with respect to a frame of the vehicle. In some embodiments, the vehicle is especially well suited for traveling over uneven terrain having large obstacles, such as rocks, boulders, logs, and other upwardly extending structures. The high clearance axle can help prevent the vehicle from hitting these types of obstacles.

In some embodiments, a rigid axle for a vehicle defines an axis of rotation for first and second wheels rotatably mounted to the axle. A central portion of the rigid axle can extend outwardly from the axis of rotation. When installed on a vehicle, the central portion is displaced vertically upward away from the axis of rotation for increased ground clearance.

In some embodiments, a high clearance axle system for a vehicle comprises a gear unit configured to couple to a drive shaft, the gear unit having a first gear unit output shaft rotatable about a first gear unit output axis and a second gear unit output shaft rotatable about a second gear unit output axis; an axle housing comprising a first arm housing, a second arm housing, and the gear unit between the first arm housing and the second arm housing; a first articulatable drive train in the first arm housing, the first articulatable drive train coupled to the first gear unit output shaft such that a first wheel coupled to the axle system is rotated about a first wheel axis when the first gear unit output shaft rotates; and a second articulatable drive train in the second arm housing, the second articulatable drive train coupled to the second gear unit output shaft such that a second wheel coupled to the axle system is rotated about a second wheel axis when the second gear unit output shaft rotates; wherein the first and second gear unit output axes are permanently offset from the first and second wheel axes.

In some other embodiments, an axle assembly comprise a gear unit having a first side and a second side opposing the first side; a first arm having a first arm inner end, a first arm outer end, and a first arm main body extending between the first arm inner end and the first arm outer end, the first arm inner end coupled to the first side of the gear unit, the first arm outer end configured to engage a first wheel carrier; and a second arm having a second arm inner end, a second arm outer end, and a second arm main body extending between the second arm inner end and the second arm outer end, the second arm inner end coupled to the second side of the gear unit, the second arm outer end configured to engage a second wheel carrier; wherein the first arm main body defines a first arm long axis and the second arm main body defines a second arm long axis, the first and second long axes define a fixed included obtuse angle.

In yet other embodiments, an axle housing for an automobile comprises a gear unit housing for accommodating a gear system, the gear unit housing having a first side and a second side; a first elongated arm coupled to the first side of the gear unit housing, the first elongated arm defining a first arm passageway for receiving a first wheel drive system for rotating a first wheel; a second elongated arm coupled to the second side of the gear unit housing, the second elongated arm defining a second arm passageway for receiving a second wheel drive system for rotating a second wheel; wherein the first elongated arm and the second elongated arm extend angularly from the gear unit housing in a downward direction when the axle housing is installed on the vehicle.

In some embodiments, a four wheeled transportation vehicle comprises a first wheel rotatable about a first axis; a second wheel rotatable about a second axis; an axle assembly interconnecting the first and second wheels to a drive shaft such that the first wheel rotates about the first axis and the second wheel rotates about the second axis when the drive shaft rotates, the axle assembly comprising a central gear unit coupled to the drive shaft, a first arm, and a second arm, the first and second arms fixedly coupled to the gear unit and extending outwardly and downwardly from opposing sides of the central gear unit towards the first and second wheels, respectively; and a suspension system movably coupling the axle assembly to a frame of the vehicle such that the axle assembly is able to move as a unit relative to the frame.

### BRIEF DESCRIPTION OF THE SEVERAL VIEWS OF THE DRAWINGS

FIG. 1 is a front view of a vehicle having high clearance front and rear axle systems.

FIG. 2 is a rear view of the vehicle of FIG. 1.

FIG. 3 is a rear view of the vehicle of FIG. 1 where a rear portion of the vehicle's body paneling is removed.

FIG. 4 is a side elevational view of a rear portion of the vehicle of FIG. 3.

FIG. 5 is a top elevational view of the rear portion of the vehicle of FIG. 4.

FIG. 6 is a pictorial view of a rear axle system, in accordance with one illustrated embodiment.

FIG. 7 is another pictorial view of the rear axle system of FIG. 6.

FIG. 8 is a rear elevational view of the rear axle system of FIG. 6.

FIG. 9 is a longitudinal partial cross-sectional view of a rear axle system, in accordance with one illustrated embodiment.

FIG. 10 is a front elevational view of a pair of articulatable drive trains, in accordance with one illustrated embodiment.

FIG. 11 is a pictorial view of a rear axle system having removable covers in a closed position, in accordance with one illustrated embodiment.

FIG. 12 is a pictorial view of the rear axle system of FIG. 11 where the covers are removed.

FIG. 13 is a pictorial view of a steerable front axle system, in accordance with one illustrated embodiment.

FIG. 14 is a front elevational view of the front axle system of FIG. 13.

FIG. 15 is a rear elevational view of the front axle system of FIG. 13.

FIG. 16 is a rear elevational view of the front axle system of FIG. 13, where a cover of a gear unit is removed.

FIG. 17 is a top elevational view of a steerable front axle system connected to a steering system, in accordance with one illustrated embodiment.

FIG. 18 is a front elevational view of a steerable front axle system, in accordance with yet another embodiment.

### DETAILED DESCRIPTION OF THE INVENTION

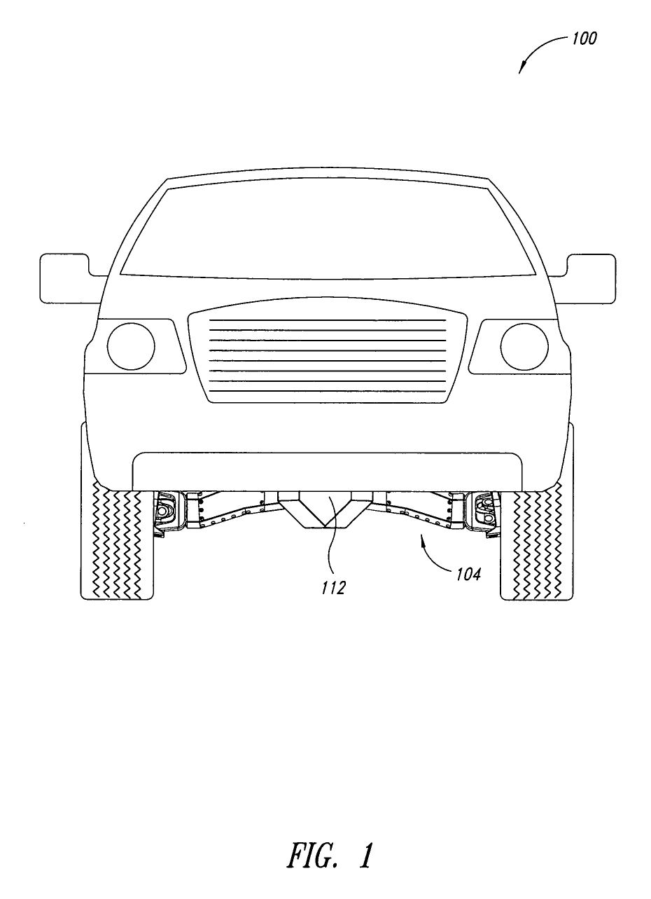

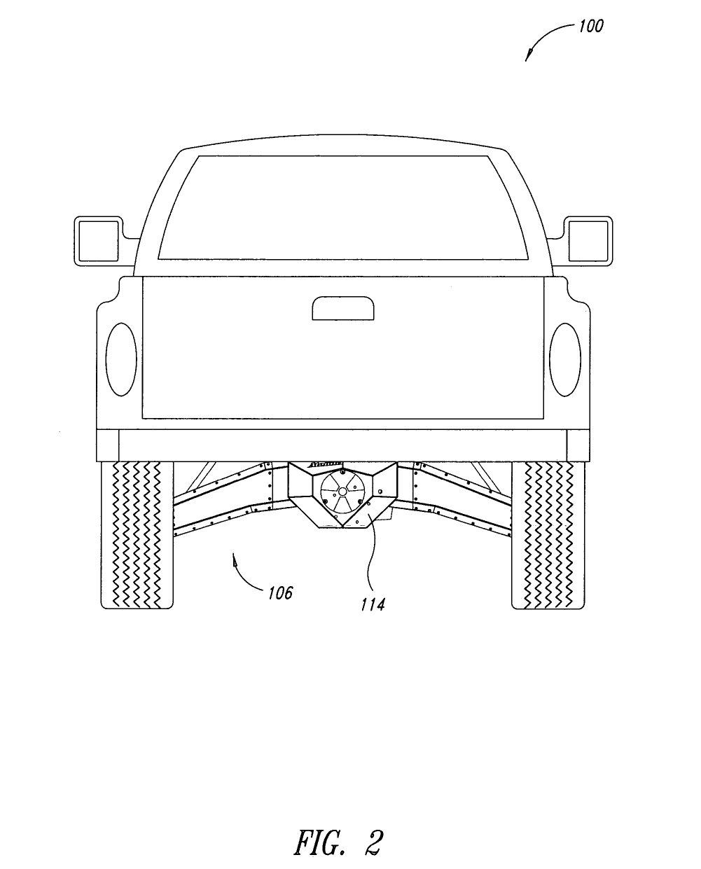

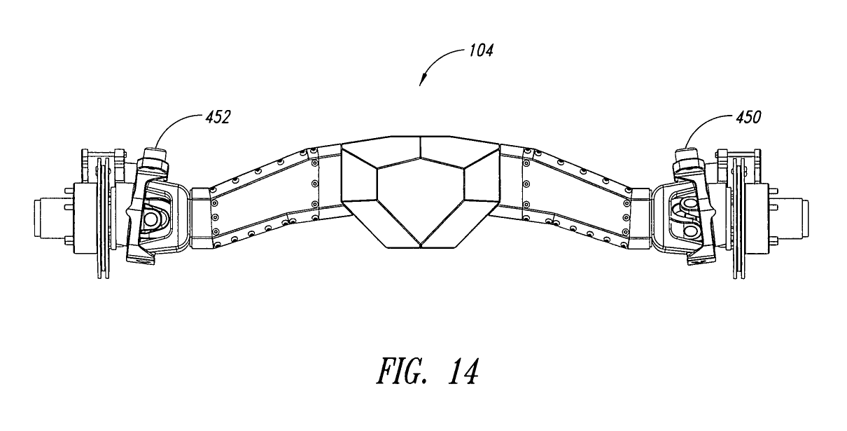

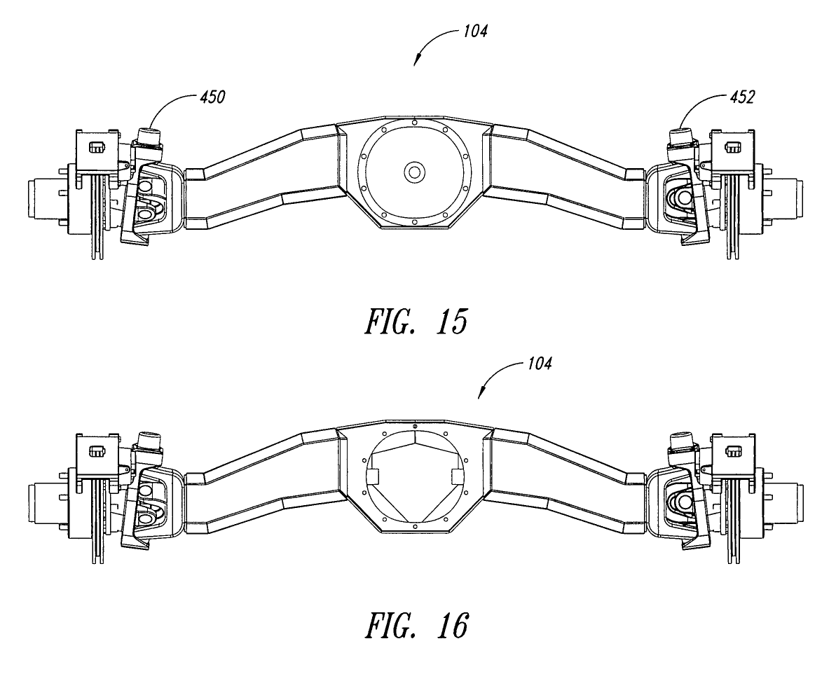

The present detailed description is generally directed to vehicles having at least one high clearance axle system. Many specific details of certain exemplary embodiments are set forth in the following description and in FIGS. 1 to 18 to provide a thorough understanding of such embodiments. One skilled in the art, however, will understand that the disclosed embodiments may be practiced without one or more of the details described in the following description. Additionally, high clearance axle systems are discussed in the context of transportation vehicles having four wheels because they have particular utility in this context. For example, high clearance axle systems are particularly well suited for off-road, four-wheel drive vehicles, such as off-road trucks, jeeps, and the like. A high clearance axle system can effectively increase the ground clearance of the off-road vehicle to reduce, limit, or prevent the axle systems from hitting objects on the ground. The axle systems can also be used in other contexts, such as, for example, with trailers (e.g., boat trailers, semi-trailers, camper trailers, and the like), carts, military vehicles, all terrain vehicles (ATVs), and the like. For example, a heavy-load trailer can have a plurality high clearance axles, each suitable for bearing heavy loads.

It should be noted that, as used in this specification and the appended claims, the singular forms “a,” “an,” and “the” include plural referents unless the content clearly dictates otherwise. For example, a drive shaft may include multiple interconnected shafts. It should also be noted that the term “or” is generally employed in its sense including “and/or” unless the content clearly dictates otherwise. For purposes of this description and for clarity, a vehicle will be described, and then a description of its components will follow.

Terms, such as “front,” “rear,” “aft,” “fore,” “right,” and “left” are used to describe the illustrated embodiments and are used consistently with the description of non-limiting exemplary applications. It will be appreciated, however, that the illustrated embodiments can be located or oriented in a variety of desired positions. Additionally, these terms are used in reference to the driver's body sitting in the vehicle, unless the context clearly indicates otherwise.

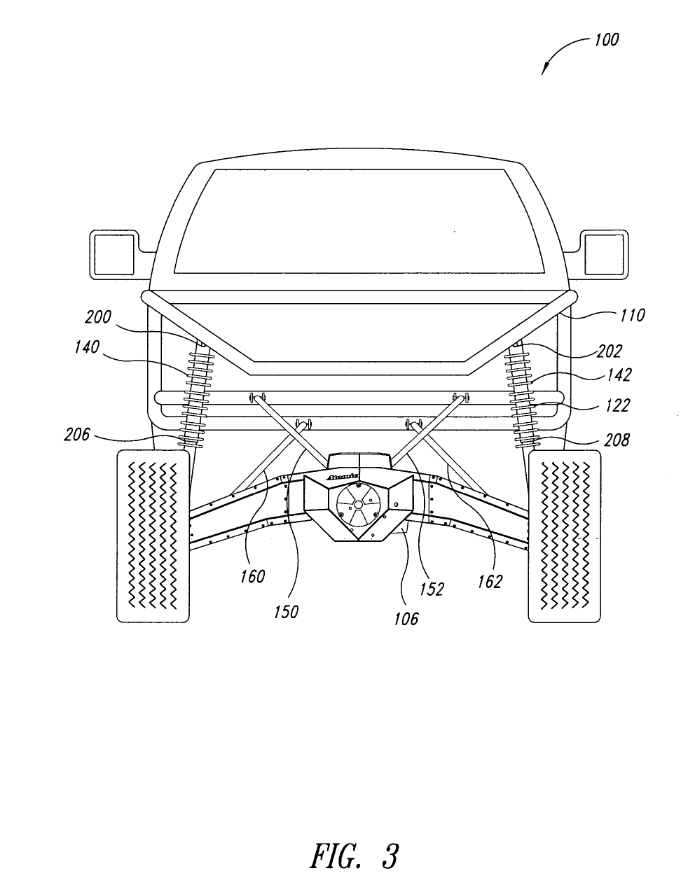

FIGS. 1 to 3 illustrate a four-wheel drive transportation vehicle 100 having a high clearance front axle system 104 and high clearance rear axle system 106. Front and rear suspension systems 122 couple the front and rear axle systems 104, 106, respectively, to a vehicle frame 110 (FIG. 3). The illustrated front and rear axle systems 104, 106 have upwardly extending central portions 112, 114, respectively, that provide an increased amount of clearance as compared to the prior art. Because of the increased clearance, the vehicle 100 can easily navigate various types of trails, paths, roads or other areas that are unsuitable for low clearance vehicles. Advantageously, the front and rear axle systems 104, 106 can reduce the likelihood of hitting any obstacles on the ground (or roadway) to prolong the useful life of the axle systems 104, 106, suspension systems 122 and other components associated with the axle systems 104, 106. As such, the vehicle 100 can access remote locations that are often inaccessible to traditional vehicles, even traditional off-road vehicles with straight axles and oversized tires.

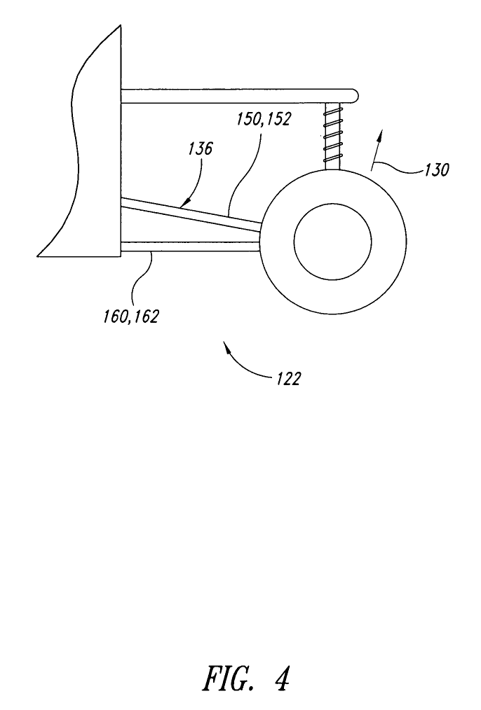

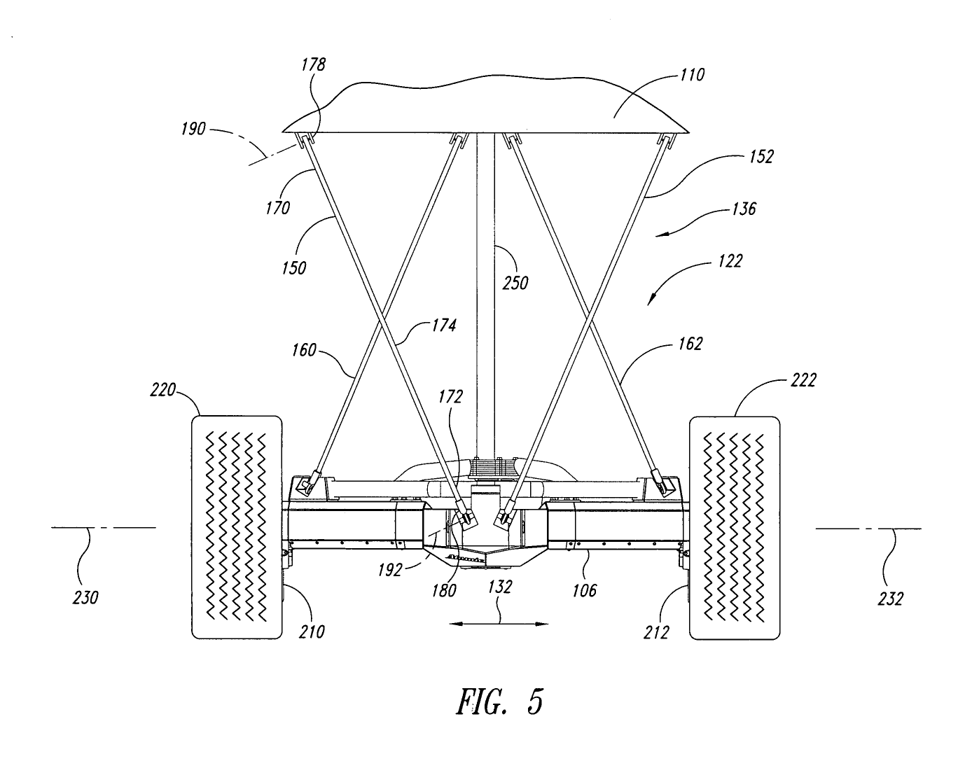

The suspension systems 122 allow for substantial movement of the respective axle systems 104, 106 relative to the frame 110. Semi-floating suspension systems, full-floating suspension systems, and other types of suspension systems can be used. The illustrated rear suspension system 122, for example, is a full-floating suspension system and is described in connection with FIGS. 4 and 5.

As used herein, the term “vehicle” is a broad term and includes, but is not limited to, four-wheeled automotive vehicles designed for passenger transportation. In some embodiments, the vehicle is a truck (e.g., a pick-up truck, cargo truck, and the like), sports utility vehicle, jeep-type vehicle, kit car or truck, rockcrawler, dune buggie, or other type of off-road vehicle. In some embodiments, vehicles can have more than two axles. For example, vehicles, such as semis, buses, recreational vehicles, or motorhomes, can have more than two axles. It is contemplated that the axle systems can be installed in vehicles that are driven on paved or smooth roadways. Additionally, the vehicle 100 can have a body lift, suspension lift, or other modification to achieve the desired ground clearance.

The axle systems disclosed herein can be installed by an original equipment manufacture (OEM) or aftermarket. In aftermarket installations, at least one of a vehicle's axles can be replaced with high clearance axle systems disclosed herein to improve vehicle performance.

With respect to FIGS. 4 and 5, the rear suspension system 122 couples the rear axle system 106 to the frame 110. The illustrated suspension system 122 is a swing arm type system that permits relatively large vertical displacements (indicated by the arrow 130 of FIG. 4) as compared to lateral displacements (indicated by the arrows 132 of FIG. 5) for enhanced drivability (for example, by increasing friction between the tires and road surface), steering, stability, and handling. Additionally, when the vehicle 100 travels over uneven or rough surfaces, the suspension system 122 can reduce or limit sudden vertical accelerations to provide a comfortable ride for any of the passengers in the vehicle 100.

The suspension system 122 has a swing arm assembly 136, extending between the axle system 106 and frame 110, and strut assemblies 140, 142 positioned at opposing ends of the axle system 106 (see FIG. 3). The horizontally orientated swing arm assembly 136 includes a pair of upper laterally spaced connecting or tie rods 150, 152 and a pair of lower laterally spaced connecting rods 160, 162. Each of the rods 150, 152, 160, 162 extends generally in the fore to aft direction. The upper pair of connecting rods 150, 152 diverges outwardly in the aft direction and the lower pair of connecting rods 160, 162 converges inwardly in the aft direction. As shown in FIG. 5, each of the two pairs of rods 150, 160 and rods 152, 162 is in a generally X-shaped configuration when viewed from above. The rods 150, 152, 160, 162 cooperate to limit lateral movement and permit substantial vertical movement of the axle system 106 relatively to the frame 110. In other embodiments, the upper pair of the connecting rods 150, 152 converge inwardly in the aft direction, and the lower pair of connecting rods 160, 162 diverge outwardly in the aft direction.

The rods 150, 152, 160, 162 can be generally similar to each other and, accordingly, the following description of one of the rods applies equally to the others, unless indicated otherwise. The rod 150 of FIG. 5 has opposing ends 170, 172 and a rod main body 174 extending between the ends 170, 172. The ends 170, 172 are movably coupled to the frame 110 and axle system 106, respectively.

In the illustrated embodiment, the end 170 of the rod 150 can be coupled to a pivoting connector 178 of the frame 110. A pivoting connector 180 pivotally couples the end 172 of the rod 150 to the axle system 106. The rod 150 can then rotate about axes of rotation 190, 192 defined by the respective pivoting connectors 178, 180. The orientation and configuration of the pivoting connectors 178, 180 and properties (e.g., stiffness) of the rods 150, 152, 160, 162 can be selected to limit or prevent appreciable side to side movement of the axle system 106. The stiffness of the rods 150, 152, 160, 162, for example, can be increased or decreased to decrease or increase side to side movement of the axle system 106 relative to the frame 110. Other types of mounting arrangements (e.g., mounting arrangements including one or more brackets, connectors, pivoting connectors, and the like) can couple the rods 150, 152, 160, 162 to the axle system 106 and frame 110.

With reference again to FIG. 3, the suspension system 122 includes strut assemblies 140, 142 extending somewhat vertically between the axle system 106 and frame 110. The strut assemblies 140, 142 provide dampening and structural support. The strut assembly 140 includes a shock absorber 200 and spring 206 that cooperate to slow down and reduce or dampen the magnitude of vibratory motions. Similarly, the strut assembly 142 includes a shock absorber 202 and spring 208. The shock absorbers 200, 202 (illustrated as piston shock absorbers) can convert kinetic energy of suspension movement into thermal energy (heat), which can be dissipated through hydraulic fluid contained in the shock absorber. Different types of strut assemblies (e.g., MacPherson struts assemblies, Chapman struts assemblies, and the like) can be selected based on the desired ride and handling.

The springs 206, 208 are coil springs. However, the vehicle 100 can also have a suspension system that includes one or more leaf springs, coil springs, or other types of springs suitable for absorbing or dampening forces. If leaf springs are used, for example, spring clamps can couple central portions of the leaf springs to the axle assembly. Opposing ends of the leaf springs can be coupled to the frame 110. Shock absorbers can be mounted between the spring clamps and vehicle frame. Vehicles (e.g., trucks, trailers, and the like) designed to carry heavy loads can utilize these types of leaf spring based suspension systems can be used on. One of ordinary skill in the art can select the appropriate combination of one or more shock absorbers, strut assemblies, springs, dampeners, leaf spring spacer blocks, leaf spring shackles, and the like to produce the desired stability and drivability.

With reference to FIGS. 5 to 7, the axle system 106 extends between opposing hubs or wheel carriers 210, 212. Wheels 220, 222 are mounted to the wheel carriers 210, 212, respectively. The wheel 220 is rotatable about a first wheel axis 230, and the wheel 222 is rotatable about a second wheel axis 232. Advantageously, the axle system 106 can be sufficiently rigid such that the first and second wheel axes 230, 232 are generally permanently aligned with one another. For example, the first and second wheel axes 230, 232 can remain substantially aligned when the vehicle 100 travels over rough roadways.

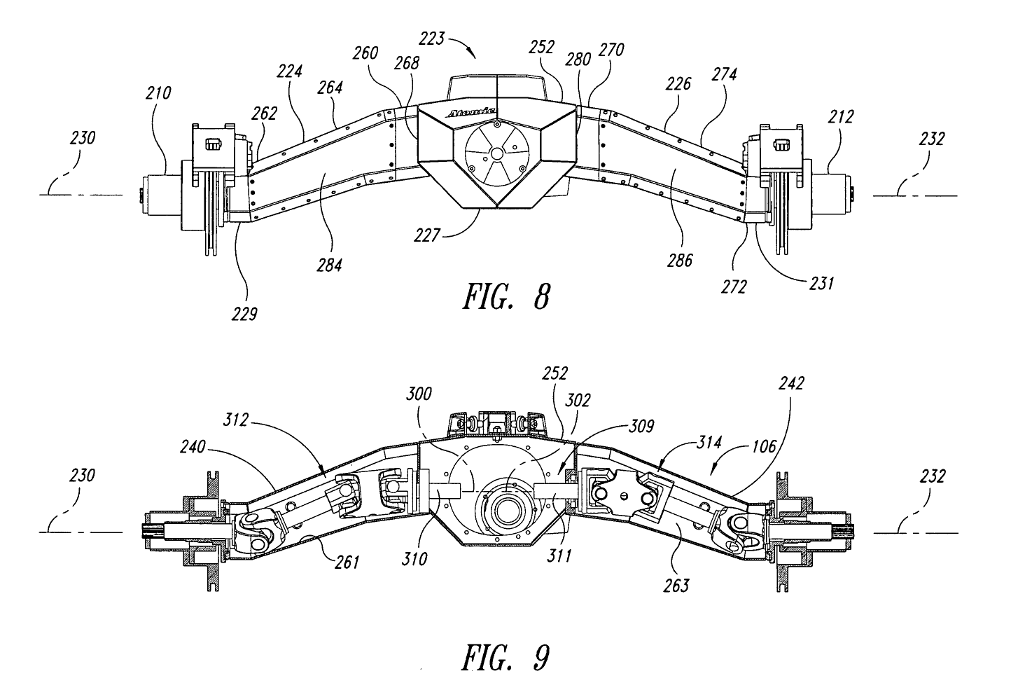

With reference to FIG. 8, the axle system 106 includes an axle main body 223 having a first arm 224, second arm 226, and gear unit 252 therebetween. The arms 224, 226 and gear unit 252 can move together as a single unit. As detailed below, various components of the vehicle's drive train can be in the arms 224, 226. To provide clearance, the lowermost portion 227 of the gear unit 252 is higher than the lowermost portions 229, 231 of the first and second arms 224, 226.

The first arm 224 has a first arm inner end 260, first arm outer end 262, and first arm main body 264 extending angularly between the inner and outer ends 260, 262. The first arm inner end 260 is fixedly coupled to first side 268 of the gear unit 252.

The second arm 226 has a second arm inner end 270, second arm outer end 272, and second arm main body 274 extending angularly between the inner and outer ends 270, 272. The second arm inner end 270 is fixedly coupled to a second side 280 of the gear unit 252. The outer ends 262, 272 are configured to engage the wheel carriers 210, 212, respectively.

With continued reference to FIG. 8, the first arm main body 264 defines a first arm long axis 284, and the second arm main body 274 defines a second arm long axis 286 angled with respect to the first arm long axis 284. In some embodiments, the first and second arm long axes 284, 286 form a fixed included obtuse angle α less than 180 degrees. The angle α can be in the range of about 100 degrees to about 170 degrees. In other embodiments, the angle α can be in the range of about 110 degrees to about 160 degrees. The angle α can be selected based on the distance between the wheels 220, 222, desired ground clearance, type and configuration of the vehicle's drive train.

When the axle system 106 is installed, the first and second arms 224, 226 extend outwardly from the gear unit 252 in a somewhat downward direction. As shown in FIGS. 8 and 9, the illustrated first arm long axis 284, second arm long axis 286, wheel axis 230, wheel axis 232, and output axes 300, 302 of the output shafts 310, 311 define a somewhat isosceles trapezoid. If the gear unit 252 is laterally offset from the centerline of the vehicle a substantial distance, the trapezoid can have sides (formed by the axes 284, 286) with different lengths.

Each of the first and second arms 224, 226 has a somewhat polygonal axial cross-sectional profile. The illustrated first and second elongate arms 224, 226 have generally square axial cross-sectional profiles. In other embodiments, the first and second elongate arms 224, 226 can have generally elliptical axial cross-sections, generally round axial cross-sections, or other axial cross-sections selected based or the shape and configuration of the drive train, desired axle stiffness, and/or materials forming the axle system 106.

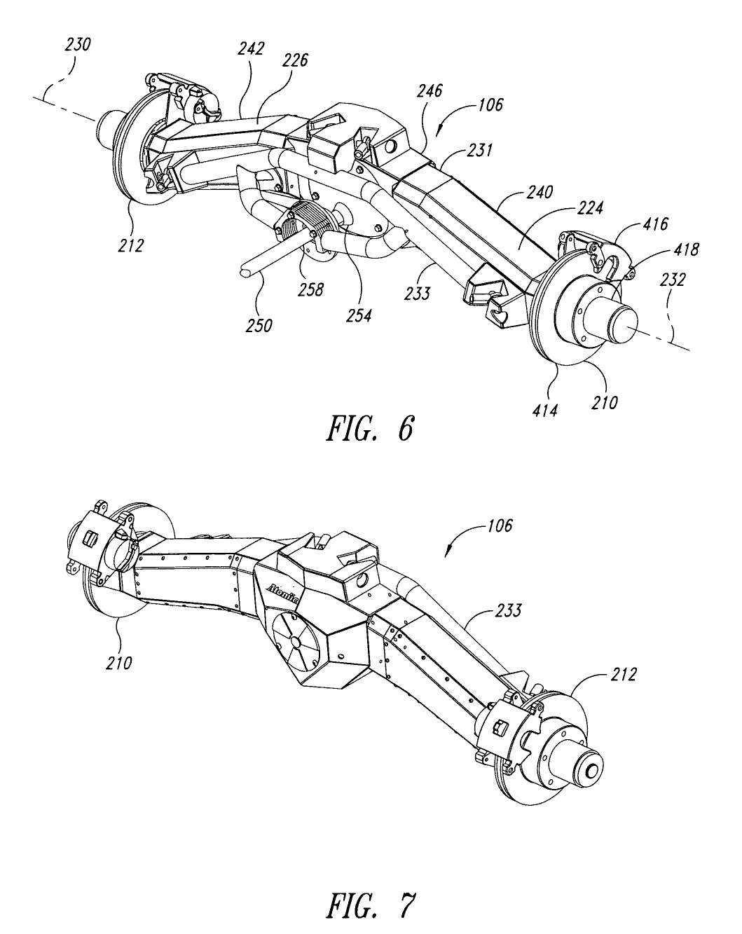

The illustrated axle system 106 of FIG. 6 includes a hollow axle housing 231 and a mounting truss 233 coupled to the axle housing 231. The axle housing 231 surrounds and protects components of a drive train positioned therein. The illustrated axle housing 231 has a first arm housing 240, a second arm housing 242, and a gear unit housing 246 between the first and second arm housings 240, 242. The first and second arm housings 240, 242 can be fixedly coupled to opposing sides of the gear unit housing 246 such that the first arm housing 240, second arm housing 242, and gear unit housing 246 move together as a unit. A drive shaft 250 can be connected to a gear system in the gear unit housing 246. The illustrated gear unit 252 has a drive shaft connector 254 fixedly coupled to a rearward end 258 of the drive shaft 250. The axle system 106 transmits rotational forces from the drive shaft 250 to one or both of the wheels carriers 210, 212.

As shown in FIG. 9, the first and second arm housings 240, 242 can define passageways 261, 263 through which the drive trains 312, 314 extend. In the illustrated embodiment, the drive trains 312, 314 are spaced from the housings 240, 242 so that they can freely rotate.

The housing 231 can be made, in whole or in part, of metal, such as steel, aluminum, titanium, or combinations thereof. In some embodiments, the housing 231 is made, in whole or part, of steel having a tensile yield strength equal to or greater than about 70,000 psi, 80,000 psi, or 90,000 psi. For example, the housing 231 can be made of steel (e.g., A656 steel) having a tensile yield strength of at least about 80,000 psi. The thickness of the housing 231 can be about ¼ inch, ½ inch, ⅓ inch. These high strength housings are especially well suited withstanding significant impacts often experienced during, for example, rock crawling competitor, racing (e.g., desert racing), and other extreme navigation. Additionally or alternatively, because the high strength housing 231 can withstand large forces, it can be used on vehicles that carry heavy loads.

With respect to FIG. 9, the axle system 106 includes a drive train 309 having gear unit 252 and articulatable drive trains 312, 314 extending between the gear unit 252 and corresponding wheels carriers 210, 212. As used herein, the term “gear unit” is a broad term and includes, without limitation, a unit or system that can transmit forces, such as torques, between a drive shaft and one or more output shafts. In some embodiments, the gear unit can be a differential (e.g., an open differential, a limited slip differential, positraction system, viscous-coupling differential, locking differential such as automatic locking differential or manual locking differential, torsen differential, and the like) that allows two or more output shafts to rotate at different speeds. In some non-limiting embodiments, the gear unit is a Ford 9 inch differential sold by the Ford Motor Company. In other embodiments, the gear unit can be a transaxle that has the functionality of a transmission and a differential. For example, a gear unit of a front axle system can be a transaxle. The gear unit can also be other types of torque converters as well as torque distributing systems.

In some embodiments, including the illustrated embodiment of FIG. 9, the gear unit 252 (internal gears of the unit 252 have been removed for clarity) includes the output shafts 310, 311 rotatable about the output axes 230, 232, respectively. The articulatable drive train 312 is in the first arm housing 240 and the other articulatable drive train 314 is in the second arm housing 242.

The articulatable drive train 312 is coupled to the output shaft 310 such that the first wheel 220 is rotated about the first wheel axis 230 when the output shaft 310 rotates. Similarly, the second articulatable drive train 314 is coupled to the second output shaft 311 such that the second wheel 222 is rotated about the second wheel axis 232 when the output shaft 311 rotates.

The first and second output axes 300, 302 can be permanently offset from the first and second wheel axes 230, 232. For example, the axes 300, 302 are offset a substantial distance from the first and second wheel axes 230, 232 such that the drive unit 252 is elevated to provide increased ground clearance when the axle assembly 106 is installed. The output axes 300, 302 in some embodiments are offset from the first and second wheel axes 230, 232 by at least about 1 inch. The offset distance can be increased or decreased to increase or decreased the clearance. In some embodiments, the first and second output axes 300, 302 are offset from the first and second wheel axes by at least about 2 inches. In some embodiments, the first and second output axes 300, 302 are offset from the first and second wheel axes 230, 232 by at least about 4 inches. In some embodiments, the first and second output axes 300, 302 are offset from the first and second wheel axes 300, 302 by at least about 5 inches. The amount of offset can be selected to achieve the desired ground clearance, height of the vehicle's center of gravity, and drive train efficiency.

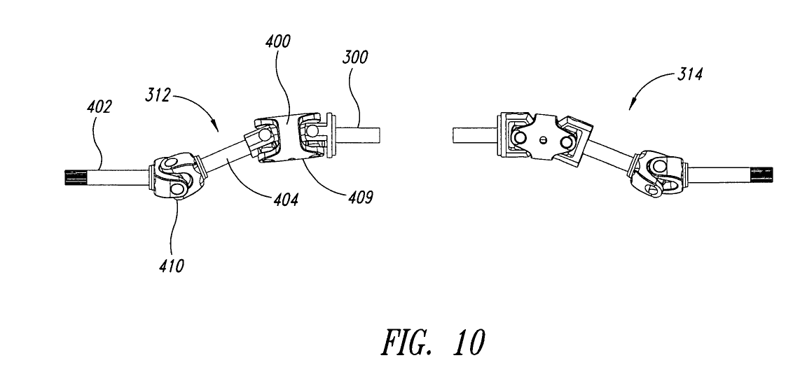

With reference to FIGS. 9 and 10, the first and second articulatable drive trains 312, 314 can transmit large torques between the gear unit 252 and the wheel carriers 210, 212. Unlike systems employing drive belts, which can slip or become worn, the drive trains 312, 314 ensure proper continuous transmission of rotational forces to the wheels 220, 222. The first and second articulatable drive trains 312, 314 can be generally similar to each other and, accordingly, the following description of one of the articulatable drive trains 312, 314 applies equally to the other, unless indicated otherwise.

The first drive train 312 includes an inner connector 400, an outer connector 402, and a shaft assembly 404 extending therebetween. The shaft assembly 404 can be coupled between the output shaft 300 and the outer connector 402 with a pair of joints 409, 410. In some embodiments, the output shaft 300 is permanently coupled to the gear unit 252. In other embodiments, the output shaft 300 is removably coupled to the gear unit 252.

The outer connector 402 can be fixedly coupled to the wheel carrier 210. In the illustrated embodiment, the outer connector 402 is a slip yoke and the wheel carrier 210 has a spline yoke that engages the slip yoke. The joints 409, 410 can be in the form of constant velocity joints (CV joints), universal joints (U-joints), or other types of joints that permit articulation between adjacent components of the drive train 312. In such embodiments, the output shaft 300 and shaft assembly 404 can remain at the same angled orientation with respect to one another. Other connections between adjacent components in the drive train 312 are also possible.

With reference again to FIG. 6, the wheel carriers 210, 212 can be generally similar to each other and, accordingly, the following description of one of the wheel carriers applies equally to the other, unless indicated otherwise. The wheel carrier 210 can be in the form of a full float hub assembly and includes a rotor assembly 414, caliper system 416 that is mounted to the rotor assembly 414, and a rotatable spindle 418. The caliper system 416 can selectively grip the rotor assembly 414 to provide braking functionality. The type of configuration of the wheel carrier used can be selected based on the desire tire size, braking capability, and desired ground clearance.

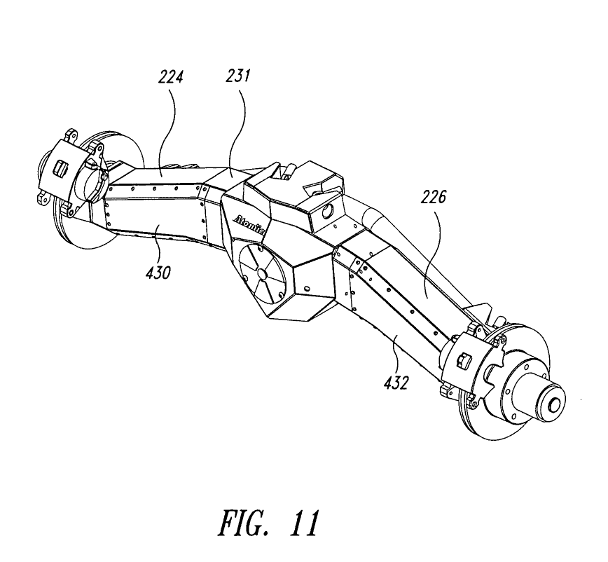

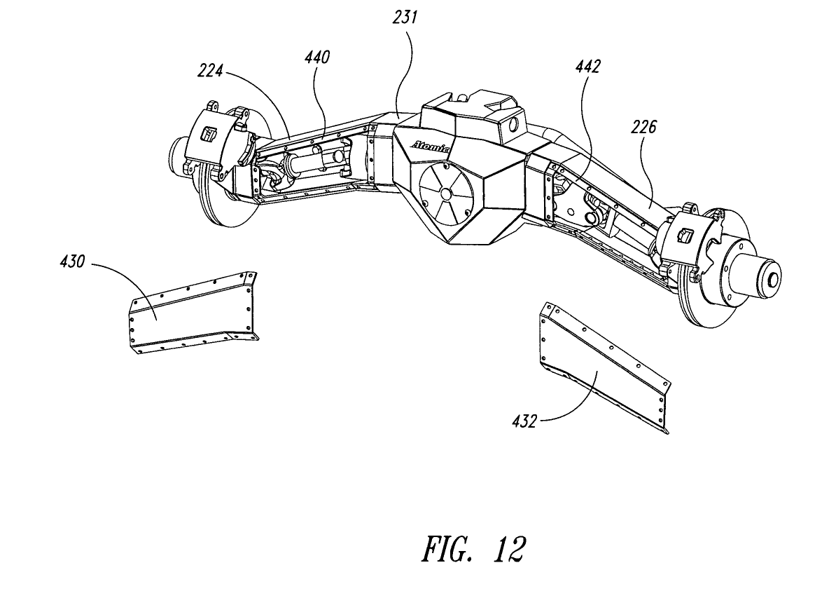

Optionally, the axle housing 231 can have one or more windows that provide access to internal components of the axle system 106. The axle housing 231 of FIGS. 11 and 12 has a pair of removable covers 430, 432 covering the windows 440, 442, respectively. In the illustrated embodiment, the first arm 224 has the generally rectangular window 440 and similarly shaped cover 430. The second arm 226 has a generally rectangular window 442 and similarly shaped cover 432. When the covers 430, 432, are removed, the windows 440, 442 provide access to the drive train 309 for performing, for example, maintenance, drive train component (e.g., universal joints, bearings, shafts, and the like) replacement, and/or visual inspections. Thus, internal components of the axle system 106 can be conveniently accessed without disassembling the entire axle system 106.

The illustrated covers 430, 432 are elongated plates removably coupled to the first and second arms 224, 226 with threaded bolts that are received in corresponding internally threaded holes in the axle housing 231. Other types of fasteners can removably coupled the covers 430, 432 to the axle housing 231. For example, snaps, latches, rod/cotter pin assemblies, and the like can be used.

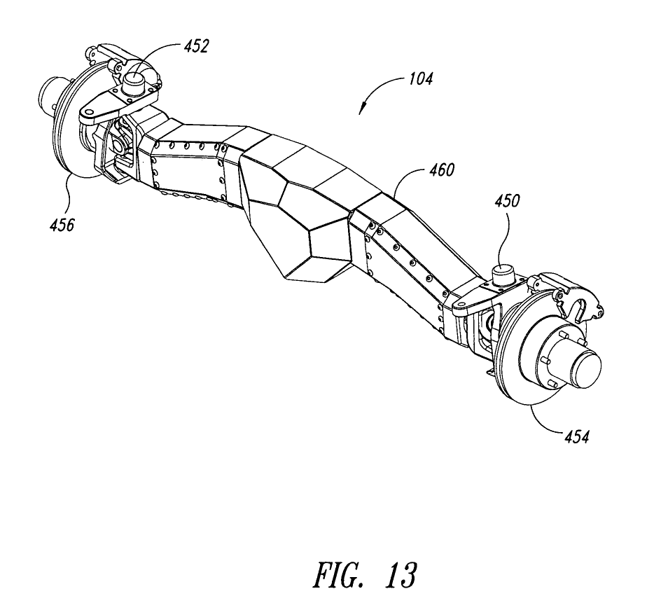

FIG. 13 to 16 illustrate the front axle system 104 that provides steering functionality. The axle system 104 can be generally similar to the rear axle system 106, except as further detailed below.

The front axle system 104 includes steering knuckle assemblies 450, 452 that permit relatively movement between the wheel carriers 454,456 and the axle main body 460. Each of the steering knuckle assemblies 450, 452 includes a kingpin steering arm and ball joint type knuckle with ending forging. Other types of steering knuckles can also be used.

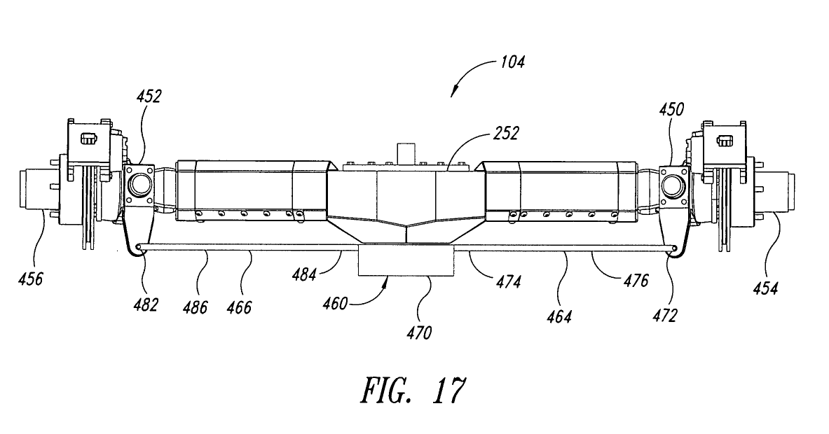

As shown in FIG. 17, a steering system 460 can be coupled to the knuckle assemblies 450, 452. The illustrated steering system 460 includes a pair of elongated tie rods 464, 466 extending from a steering unit 470 to the knuckle assemblies 450, 452. The tie rod 464 has an outer end 472 pivotally coupled to the knuckle assembly 450, an inner end 474 coupled to the steering unit 470, and an elongated body 476 extending between the outer and inner ends 472, 474. The tie rod 466 has an outer end 482 pivotally coupled to the knuckle assembly 452, an inner end 484 coupled to the steering unit 470, and an elongated body 486 extending between the outer and inner ends 482, 484. The illustrated steering assembly 460 is a recirculating-ball steering unit that can include, for example, a recirculating ball gearbox, a pitman arm, and power steering pump.

In other embodiments, the steering system 460 can be a rack-and-pinion steering system. The tie rods 464, 466 can be connected to a rack in the steering unit 470. A rotatable pinion in the unit 470 can drive the rack laterally to rotate each wheel carriers 454, 456 about a generally vertical oriented axis of rotation. Thus, various types of steering systems can selectively move the wheel carriers 454, 456 inwardly or outwardly.

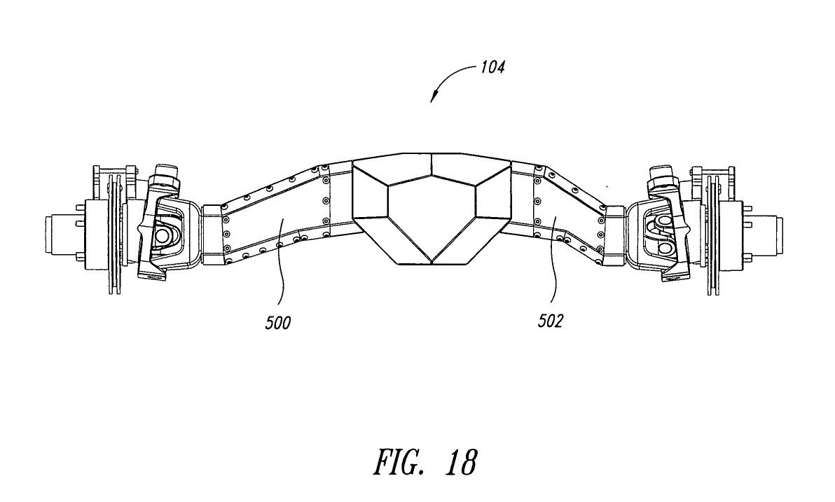

The axle system 104 can have an offset gear unit 252. The offset can be selected based on the position and orientation of the drive shaft in which the axle system 104 is connected. In some embodiments, the axle system 104 has an asymmetric configuration. As shown in FIG. 18, the axle system 104 has a long elongate arm 500 and a short elongate arm 502. The configuration of the elongate arms 500, 502 can be chosen to mate the gear unit of the axle with a drive shaft.

Although the axle system 104 is used as a front axle in FIGS. 1-3, the axle system 104 can also be used as a rear axle to provide rear wheel steering. Thus, the axle system 104 can be used in four-wheel steering (or all wheel steering) vehicles to increase vehicle stability, decrease turning radius, and the like.

In some embodiments, at least one of the axle systems 104,106 can be a load bearing dead axle. That is, at least one of the axle systems 104, 106 can operate independent of the vehicle's drivetrain, thereby permitting free rotation of its wheels. For example, the dead axles can be installed in trailers, trucks, and other load carrying vehicles. Thus, the illustrated axle system can be in the form of a tag axle, pusher axle, or other type of dead axle.

The axle systems described herein can be installed aftermarket to increase vehicle ground clearance, improve vehicle performance and durability, and enhance the overall appearance of the vehicle. In some embodiments, at least one of the front and rear axle systems of the vehicle 100 can be replaced with the front and/or rear axle systems 104, 106. To increase rear end ground clearance, for example, the rear axle can be removed from the vehicle. The axle can be decoupled from the suspension system or other components. After decoupling the axle, the high clearance axle 106 (preferably providing ground clearance greater than the ground clearance of the previously installed axle) can be installed without removing or modifying the vehicle's suspension system. In other embodiments, the suspension system can be replaced or modified to improve performance of the axle system 106. For example, the suspension system can be replaced with a suspension system 112 that provides increased axle suspension travel. In this manner, a vehicle's ground clearance can be effectively increased. The aftermarket high clearance can travel over high obstacles.

Various methods and techniques described above provide a number of ways to carry out the invention. Of course, it is to be understood that not necessarily all objectives or advantages described may be achieved in accordance with any particular embodiment described herein. Thus, for example, those skilled in the art will recognize that the methods may be performed in a manner that achieves or optimizes one advantage or group of advantages as taught herein without necessarily achieving other objectives or advantages as may be taught or suggested herein.

Furthermore, the skilled artisan will recognize the interchangeability of various features from different embodiments disclosed herein. Similarly, the various features and acts discussed above, as well as other known equivalents for each such feature or act, can be mixed and matched by one of ordinary skill in this art to perform methods in accordance with principles described herein. Additionally, the methods which are described and illustrated herein are not limited to the exact sequence of acts described, nor are they necessarily limited to the practice of all of the acts set forth. Other sequences of events or acts, or less than all of the events, or simultaneous occurrence of the events, may be utilized in practicing the embodiments of the invention.

Although the invention has been disclosed in the context of certain embodiments and examples, it will be understood by those skilled in the art that the invention extends beyond the specifically disclosed embodiments to other alternative embodiments and/or uses and obvious modifications and equivalents thereof. Accordingly, it is not intended that the invention be limited, except as by the appended claims.

What is claimed is:

1. A high clearance axle system for a vehicle, the axle system comprising:
a gear unit configured to couple to a drive shaft, the gear unit having a first gear unit output shaft rotatable about a first gear unit output axis and a second gear unit output shaft rotatable about a second gear unit output axis;
an axle housing comprising a first arm housing, a second arm housing, the gear unit being positioned between the first arm housing and the second arm housing;
a first articulatable drive train in the first arm housing, the first articulatable drive train coupled to the first gear unit output shaft such that a first wheel coupled to the axle system is rotated about a first wheel axis when the first gear unit output shaft rotates; and
a second articulatable drive train in the second arm housing, the second articulatable drive train coupled to the second gear unit output shaft such that a second wheel coupled to the axle system is rotated about a second wheel axis when the second gear unit output shaft rotates;
wherein the first and second gear unit output axes are permanently offset from the first and second wheel axes.

2. The axle system of claim 1 wherein the first arm housing and the second arm housing are fixedly coupled to opposing sides of the gear unit such that the first arm housing, the second arm housing, and the gear unit move together as a unit.

3. The axle system of claim 1 wherein the first wheel axis and the second wheel axis are generally permanently aligned with one another.

4. The axle system of claim 1 wherein the first gear unit output axis is vertically offset from the first wheel axis by at least about 1 inch, and the second gear unit output axis is vertically offset from the second wheel axis by at least about 1 inch.

5. The axle system of claim 1 wherein the first arm housing extends along a first arm longitudinal axis and the second arm housing extends along a second arm longitudinal axis that is at a fixed angle with respect to the first arm longitudinal axis.

6. The axle system of claim 5, wherein the fixed angle is in the range of about 100 to about 170 degrees.

7. An axle assembly comprising:
a gear unit having a first side and a second side opposing the first side;
a first arm having a first arm inner end, a first arm outer end, and a first arm main body extending between the first arm inner end and the first arm outer end, the first arm inner end coupled to the first side of the gear unit, the first arm outer end configured to engage a first wheel carrier; and
a second arm having a second arm inner end, a second arm outer end, and a second arm main body extending between the second arm inner end and the second arm outer end, the second arm inner end coupled to the second side of the gear unit, the second arm outer end configured to engage a second wheel carrier;
wherein the first arm main body defines a first arm long axis and the second arm main body defines a second arm long axis, the first and second long axes define a fixed included obtuse angle.

8. The axle assembly of claim 7 wherein the included obtuse angle is in the range of about 120 degrees to about 170 degrees.

9. The axle assembly of claim 7 wherein the first arm and the second arm extend generally angularly from the gear unit.

10. The axle assembly of claim 7, further comprising:
a first gear unit output shaft and second gear unit output shaft rotatable about first and second axes, respectively; and
wherein the first wheel carrier is configured to rotate a first wheel about a first wheel axis, the second wheel carrier is configured to rotate a second wheel about a second wheel axis, the first axis of the first gear unit output shaft is spaced from the first wheel axis by at least 1 inch, the second axis of the second gear unit output shaft is spaced from the second wheel axis by at least 1 inch.

11. The axle assembly of claim 7 wherein the gear unit, the first arm, and the second arm move together as a rigid unit.

12. An axle housing for an automobile comprising:
a gear unit housing for accommodating a gear system, the gear unit housing having a first side and a second side;
a first elongated arm coupled to the first side of the gear unit housing, the first elongated arm defining a first arm passageway for receiving a first wheel drive system for rotating a first wheel;
a second elongated arm coupled to the second side of the gear unit housing, the second elongated arm defining a second arm passageway for receiving a second wheel drive system for rotating a second wheel;
wherein the first elongated arm and the second elongated arm extend angularly from the gear unit housing in a downward direction when the axle housing is installed on the vehicle.

13. The axle housing of claim 12 wherein the first elongated arm and the second elongated arm are sufficiently rigid such that first and second wheel axes about which the first and second wheels rotate are generally permanently aligned with one another.

14. The axle housing of claim 12 wherein the first and second elongated arms have free ends, each of the free ends has a bottommost surface lower than a bottommost surface of the gear unit housing.

15. A four wheeled transportation vehicle comprising:
a first wheel rotatable about a first axis;
a second wheel rotatable about a second axis;
an axle assembly interconnecting the first and second wheels to a drive shaft such that the first wheel rotates about the first axis and the second wheel rotates about the; second axis when the drive shaft rotates, the axle assembly comprising a central gear unit coupled to the drive shaft, a first arm, and a second arm, the first and second arms fixedly coupled to the gear unit and extending outwardly and downwardly from opposing sides of the central gear unit towards the first and second wheels, respectively; and
a suspension system movably coupling the axle assembly to a frame of the vehicle such that the axle assembly is able to move as a unit relative to the frame.

16. The four wheeled transportation vehicle of claim 15 wherein a substantial portion of the gear unit is positioned higher than the first and second axes.

17. The four wheeled transportation vehicle of claim 15 wherein the drive shaft axis and the first axis define a first offset distance, and the drive shaft axis and the second axis define a second offset distance, and each of the first and second offset distances is equal to or greater than about 1 inch.

18. The four wheeled transportation vehicle of claim 15 wherein a lowermost portion of the gear unit is higher than a lowermost portion of the first arm and a lowermost portion of the second arm.

19. The four wheeled transportation vehicle of claim 15, further comprising:
a first wheel carrier coupled to an outer end of the first arm, the first wheel carrier carrying the first wheel;
a second wheel carrier coupled to an outer end of the second arm, the second wheel carrier carrying the second wheel;
a first linkage system extending along the first arm, the first linkage system coupled to the first wheel carrier and the gear unit; and
a second linkage system extending along the second arm, the second linkage system coupled to the second wheel carrier and the gear unit;
wherein the first and second linkage systems rotate the first wheel and second wheel, respectively, in response to rotation of the drive shaft.

20. The four wheeled transportation vehicle of claim 15 wherein the axle assembly is sufficiently rigid such that the first axis and the second axis are generally fixed relatively to one another and aligned when the axle assembly is moved vertically relative to the frame.

21. The four wheeled transportation vehicle of claim 15 wherein the first and second arms extend downwardly past a bottommost surface of the gear unit.

22. The four wheeled transportation vehicle of claim 15 wherein the suspension system comprises:
a pair of upper horizontally spaced connecting rods extending from the axle assembly to the frame; and
a pair of lower horizontally spaced connecting rods extending from the axle assembly to the frame;
wherein one of the upper or lower pairs of the connecting rods diverge outwardly in an aft direction and the other one of the upper or lower pairs of the connecting rods converges inwardly in the aft direction.
